(19) United States
(12) Patent Application Publication
(10) Pub. No.: US 2005/0240795 A1
(43) Pub. Date: Oct. 27, 2005

(54) Resource management system and method

(75) Inventors: Gabor Paller, Budapest (HU); Piotr Cofta, Dublin (FI); Jaana Majakangas, Tampere (FI)

Correspondence Address: FOLEY & LARDNER, 321 NORTH CLARK STREET, SUITE 2800, CHICAGO, IL, 60610-4764, US

(73) Assignee: Nokia Corporation

(21) Appl. No.: 10/832,546

(22) Filed: Apr. 27, 2004

(51) Int. Cl. H04L 12/56

(52) U.S. Cl. 714/1

(57) ABSTRACT

A method and apparatus for resource management are disclosed. The method includes detecting a change in availability of one or more resources, determining whether a dependency exists between the resources and a managed component, and propagating the change in availability to the managed component when a dependency exists. The apparatus for resource management includes a media manager adapted to detect a change in availability of one or more resources, a resource inventory having information indicative of one or more dependencies between the resources and one or more managed components, and a management agent adapted to propagate the change in availability to a managed component when a dependency exists between the managed component and the resources.

### BACKGROUND OF THE INVENTION

The present invention relates generally to the field of system management, and particularly to systems and methods of managing resources required by various components in a computer system, for example.

Reliable management of resources in a computer system, for example, requires that a management system is aware of the consequences that a management action can cause in the system. Resources may be located on a variety of media types. For management purposes, the simplest media is fixed media, such as hard drives, because resources located on fixed media are under total control of the management system. On the other hand, removable media may cause difficulties, because managed resources on the removable media may appear or disappear when the media is inserted or removed, respectively.

Package management tools exist to track the installation, uninstallation, and upgrading of software applications and their various components. For example. RedHat Package Manager (RPM) is an open packaging system, available for anyone to use, which runs on Red Hat Linux as well as other Linux and UNIX systems. RPM is configured to track the dependencies between software applications and their various components. It can be used to track dependencies between various components of a software application and verify to the user the usability of a software application by verifying that all required components are currently installed on a system. During software installation, dependency information can be checked and if one or more dependencies needed to run the software being installed are not met, the software is not installed.

A useful way of mapping these dependencies is a dependency graph. As such, dependency graphs can be used in system management. In a dependency graph, resources can be decribed as nodes of the graph and dependencies are represented as directed deges in the graphs. Using this graph it can be possible to find out for example, how the unavailability of one resource affects the overall operation of a system.

However, conventional package management tools are generally only configured to verify the integrity of a system or software application in response to a user inquiry. Furthermore, conventional systems are typically configured to notify the user of the integrity of an application, but do not notify the application itself. In addition, conventional package management tools typically only tell the user if all the proper components are in place to run a software application. They are not generally configured to notify a user that some components of a software application are missing, but that the application can still be used even though some functionality of the software application may not be available. Furthermore, conventional systems do not check and are not suitable for tracking and managing hardware dependencies.

Automatic recognition of removable media can be done in a variety of ways, such as using UNIX automount or Windows Plug&Play. These types of methods and systems are typically configured to recognize when hardware is added or removed from a system, but do not indicate how this affects the system since no dependency information is kept for the installed or removed hardware.

Problems can arise in a managed system when resources, such as an application component or a data store, are stored on removable media. If media containing critical resources is removed, part of the system may cease to function. In order to be able to manage the system effectively, the management system must know the current state of the system. When the media is inserted or removed, thereby changing the state of the system, the management system needs to be notified of the changes in order to manage other components which may depend on resources whose availability has changed.

As such, there is a need for a resource management system, method, device and computer code product for tracking the availability system resources based on media events triggered by the insertion or removal of removable media from a system. There is also a need for a resource management system, method, device, and computer code product for notifying a software application directly of it usability based on the available resources in a system. There is an additional need for a resource management system, method, device and computer code product for tracking when a software application can be run on a limited functionality basis even though some components of the software application are not available on the system.

### SUMMARY OF THE INVENTION

Embodiments of the invention relate to a methods, systems, devices and computer code products for resource management. The embodiments includes detecting a change in availability of one or more resources, determining whether a dependency exists between the resources and a managed component, and propagating the change in availability to the managed component when a dependency exists. The embodiments can be triggered based on media events indicating the insertion or removal of removable media. In addition, the embodiments can include tracking soft dependencies (without which a managed component can still operate on a limited functionality basis) and hard dependencies (without which a managed component cannot operate).

In another embodiment, an apparatus for resource management includes a media manager adapted to detect a change in availability of one or more resources, a resource inventory having information indicative of one or more dependencies between the resources and one or more managed components, and a management agent adapted to propagate the change in availability to a managed component when a dependency exists between the managed component and the resources.

### BRIEF DESCRIPTION OF THE DRAWINGS

FIG. 1 is a schematic illustration of a resource management system according to an embodiment of the invention;

FIG. 2 is a flowchart illustrating the operation of a resource management system according to an embodiment of the invention; and

FIG. 3 is a block diagram of one embodiment of a device employing a resource management system according to the present invention.

### DETAILED DESCRIPTION OF THE PREFERRED EMBODIMENTS

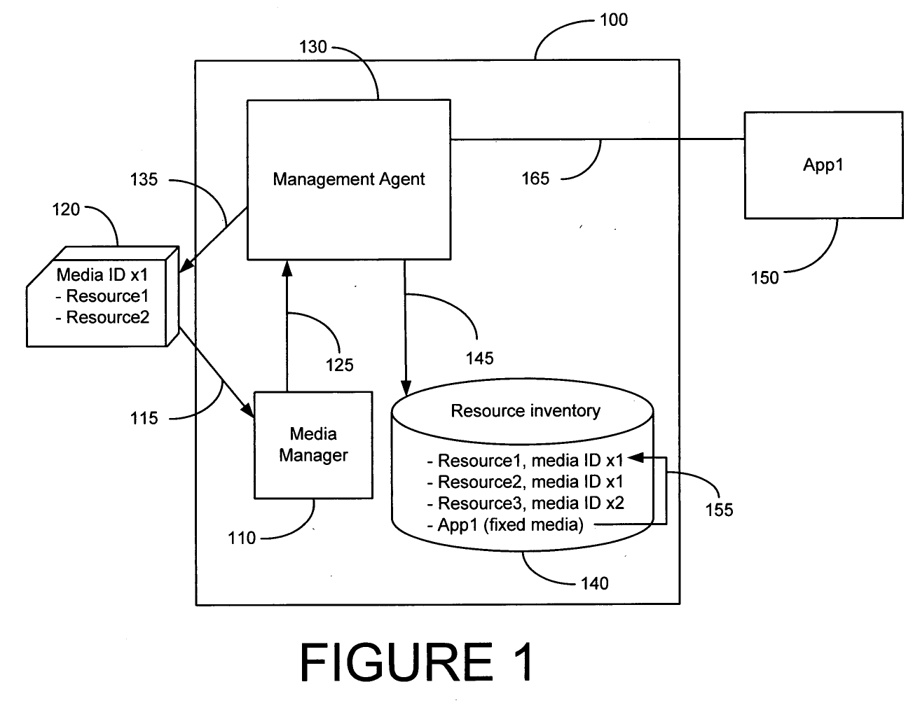

Referring to FIG. 1, an embodiment of a resource management system is illustrated. The management system 100 includes a media manager 110 which is capable of detecting addition or removal of removable media, such as removable medium 120. The media manager 110 may be a low-level software component that manages a removable media bay (not shown) into which the removable medium 120 can be mounted or inserted. The media manager 110 is able to detect when the removable medium 120 is inserted or removed, as indicated by the line 115, and to convey the insertion or removal to a management agent 130, described in further detail below.

The removable medium 120 may be any of a variety of forms such as CDROM, floppy disc, flash card and smart cover, for example. The removable medium can also be another device which is connected to management system 100 using some short range connection, like Bluetooth, infrared or cable. In the illustrated embodiment, the removable medium 120 contains a number of resources, which may be software components (such as, among other things, code or static resources needed for a component implementing certain functionality) or data stores (such as, among other things, databases or files). Each resource is provided with a resource identifier. The resource identifier can be, for example, the name of the file or the name of the file in combination with an identifier of the removable media 120.

Upon detection of the addition or removal of the removable medium 120, the media manager 110 notifies the management agent 130, as indicated by line 125. The management agent 130 is adapted to coordinate the management operations on a computer system and to keep track of the state of the system. The management agent 130 may be implemented as a separate software component or it can be part of media manager 110.

If the notification from the media manager 110 indicates the addition of the removable medium 120, the management agent 130 evaluates (e.g., searches or scans) the removable medium 120 (line 135) to determine which resources have become available. When management agent 130 evaluates the removable medium 120, the resource identifiers may be used to determine which resources are present on the removable medium 120 or the management agent 130 can use the content, like file names, file attribures, file contents, etc. of removable medium 120 to decide what resources are available.

If the notification indicates the removal of the removable medium 120, the management agent 130 notes which previously available resources have become unavailable.

Once the management agent 130 determines which resources have become available or unavailable, a resource inventory 140 is inspected (line 145) to determine the existence of dependencies relating to the resources. The resource inventory 140 may be updated when new applications or other managed components are installed on the computer system. During installation, a dependency may be noted between a number of components, and that dependency may be stored in the resource inventory 140.

The application may also register for certain types of components (determined by data store internal structure, MIME type or file extension, for example). When the removable medium 120 is inserted, the management agent 130 can scan for the registered components and notifies the applications that registered for that type of component. Applications may be given a chance to accept or reject the registeration of the component on the removable media 120. In this regard, the application may perform deeper analysis of the component and can determine whether to accept or reject the registeration of the component.

The resource inventory 140 may be a local database that maintains resource identifiers and dependencies among resources and managed components. The resource inventory may be in the form of a database or a list. In an embodiment, the resource inventory may be implemented as a dependency graph. In another embodiment, the resource inventory may be a list annotated with dependency meta-information.

The resource inventory 140 may include references to a variety of components. Two such components are software components and data stores. Exemplary software components may be applications on fixed media, as well as segments of applications on removable media. Dependencies can exist among any entries in the resource inventory 140. Any entry can depend on any number of other entries. For example, one software component can depend on another software component (e.g., the second software component needs to be available for the first one to function properly), one software component can depend on a data store (e.g., a data store must be present in order for the software component to work properly), or a data store can depend on another data store (e.g., one logical database may be located in multiple physical databases).

The dependencies may be either hard dependencies or soft dependencies. A hard dependency may be a dependency that makes a software component, such as an application, or a data store unusable if the dependency is not satisfied. On the other hand, when a soft dependency is not satisfied, the dependent software component or data store may be used with reduced functionality, for example.

In order to provide additional security against removable media containing a virus that tries to look like an installed software component or trusted data store, for example, the inventory may contain a checksum so that the data on the removable media can be checked for tampering. The checksum may be updated whenever the resource is modified, for example.

Alternatively, the removable medium 120 itself may have an identifier which can be stored together with the resource identifier. For example the removable medium 120 may have a secure unique identifier that can be queried but cannot be forged. In another embodiment, a random identifier can be generated when the removable medium 120 is taken into use for the first time. Instead of the checksum, the media identifier can be stored in the resource inventory.

When the management agent 130 determines that the resource inventory 140 indicates the existence of a dependency between a resource on the removable medium 120 and a managed component, such as the dependency indicated by line 155, the management agent propagates (line 165) the change in the availability of the resource to the managed component, such as an application 150.

In the illustrated example, if the removable medium 120 having the title “Media ID x1” is inserted, the management agent 130 determines that the resources “Resource1” and “Resource2” have become available. The management agent 130 then inspects the resource inventory 140 for dependencies involving the resources becoming available. The management agent 130 notes that the resource inventory 140 indicates a dependency involving “Resource1” and an application “App1”.

The propagation may take several forms. For example, the management agent 130 may mark the application 150 as being usable when the change in availability of the resource includes the resource becoming available. Similarly, the application 150 may be marked as unusable when the change in availability of the resource includes the resource becoming unavailable. The marking may be transparent to the user and may be implemented as a change in an internal store. In this regard, when a user attempts to launch the application 150, the user may be presented with a message indicating the application 150 is unusable due to missing resources, for example. In other embodiments, the marking may be visible to the user. For example, an icon representing the application 150 may be changed in appearance to indicate the usable or unusable status of the application 150.

The propagation may also take the form of either starting (resource becoming available) or stopping (resource becoming unavailable) the application 150. In this regard, when the resource on the removable medium 120 becomes available, the management agent 130 may automatically launch the application 150. Similarly, the management agent 130 may stop a running application 150 if a necessary resource becomes unavailable.

In other embodiments, the propagation may take the form of a message from the management agent 130 to the application 150 indicating the change in availability of the resource. In this regard, the effects of the change in availability are controlled by the application. For example, the application 150 may determine that the dependency with the resource is a soft dependency. Thus, the application 150 may launch and operate with reduced functionality if the change in availability includes the resource becoming unavailable. In the case of a hard dependency, the application 150 may not launch but may present a message to the user indicating the missing resource. In cases when a resource is made available through the insertion of a removable medium 120, for example, the notification may also include an address indicating the location of the resource. Thus, the application 150 is able to directly access the resource.

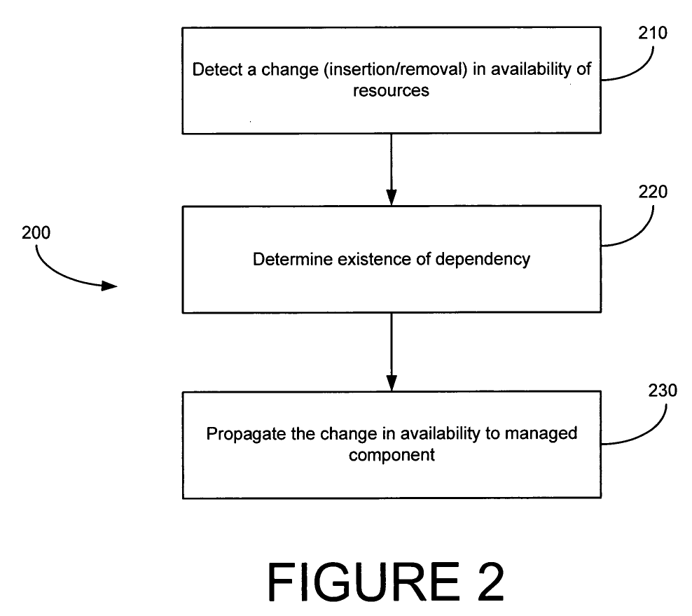

FIG. 2 is a flow chart illustrating the operation of a resource management system. The method 200 includes detecting a change in the availability of resources (block 210). As noted above, the change in availability may include the insertion or removal of a medium containing the resources. The resources may include a software component or a data store.

At block 220, the method 200 determines whether a dependency exists between the resources and a managed component. This may be achieved through the evaluation of a resource inventory, which may be in the form of a dependency graph. The managed component may be a software application or a data store.

At block 230, the change in availability of the resource is propagated to the managed component if a dependency is determined to exist. The propagating can take several forms, as described above with reference to FIG. 1.

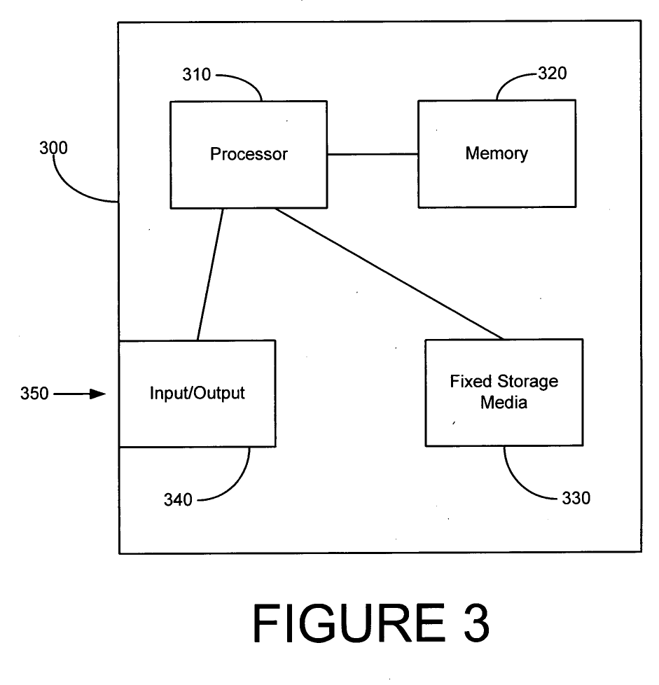

FIG. 3 illustrates one embodiment of a device employing resource management according to the present invention. The device 300 can include a processor 10, memory 320, a fixed storage media 330, such as a hard drive, and an input/output interface 340. The input/output interface 340 can include a slot or bay 350 for insertion of a removable media. The media manager is configured to monitor the input/output interface 340 to detect when removable media is inserted into or removed from bay 350. Upon insertion or removal, the media manager generates a media event which is sent to the management agent. In one embodiment, the management agent can be a software component stored in fixed storage media 330 and loaded into memory 320 and run on processor 310 upon startup of the device 300. Upon notification of a media event, the management agent can update the resource inventory (which can be stored in memory 320) and notify any applications or other managed components affected by the media event.

In one example, the managed component may be a software component “Phonebook” installed on a fixed medium. A phonebook database may be located on a removable media. When the managed component “Phonebook” is installed, the data store is not present. The resource inventory may contain the information that “Phonebook” depends on the phonebook database but the database is not present. Therefore, the managed component cannot be started. When a user inserts the removable medium with the phonebook database, the management agent is notified and inspects the removable medium. The management agent finds that the phonebook database is present now and inspects the resource inventory. The management agent determines that “Phonebook” depends on the phonebook database and propagates the change in availability of the resource to the “Phonebook,” which can be now started. The managed component may be marked as “startable” or may be automatically launched by the management agent when the dependency is resolved.

When the user removes the removable medium, the management agent receives a notification from the media driver and determines that the phonebook database on the removable medium is no longer available. Inspecting the resource inventory, the management agent determines the existence of the dependency and stops the managed component.

In another example, an optional part of a software component, such as a chess game, is placed on a removable medium, and there is a soft dependency between the main part of the software component on the fixed medium and the optional part on the removable medium. The computer player of the chess game without the resource on the removable medium may be adapted for novice play. An expert chess engine may be available on removable medium. When the user inserts the removable medium, the media driver sends a notification to the management agent. The management agent examines the removable medium and detects the availability of the resource. Upon evaluation of the resource inventory, the management agent determines the existence of a soft dependency between the resource and the chess game. Accordingly, the management agent propagates the change in availability of the resource, making the chess game available with the expert computer player.

In another example, an application launcher user interface may be affected by the availability of the removable media. For example, a user may install an enterprise application, which is located on a fixed medium but has a large database that is located on a removable medium. The application is installed, the database is created on the removable media, and an icon appears on the desktop that can be used to launch the application. The management agent registers a hard dependency between the application and the database in the resource inventory. When the removable medium containing the database is removed, the management agent evaluates the resource inventory and determines the existence of a hard dependency. Thus, the management agent marks the application as “not usable.” As the enterprise application is “not usable,” the icon on the desktop may change its appearance (for example, it may be shaded grey or made invisible) to indicate to the user that the application is not available. The user may have the option of querying why the application is not usable. A desktop application, in cooperation with the management agent, can inform the user that the removable media needs to be inserted in order to use the application.

Thus, the disclosed embodiments of resource management systems and methods can manage a system, even in the presence of removable media.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

1. A method of resource management, comprising:
detecting a change in availability of one or more resources;
determining whether a dependency exists between said one or more resources and a managed component; and
propagating said change in availability to said managed component when said step of determining determines the existence of a dependency.

2. The method of claim 1, wherein said step of detecting a change includes detecting at least one of an insertion or a removal of a medium containing said one or more resources.

3. The method of claim 1, wherein said one or more resources includes at least one of a software component or a data store.

4. The method of claim 1, wherein said step of determining includes evaluating a resource inventory.

5. The method of claim 4, wherein said resource inventory includes a dependency graph.

6. The method of claim 1, wherein said managed component is at least one of a software application or a data store.

7. The method of claim 1, wherein said step of propagating includes changing a status of said managed component.

8. The method of claim 7, wherein said step of propagating includes marking said managed component as usable when said change in availability includes a resource becoming available and as unusable when said change in availability includes a resource becoming unavailable.

9. The method of claim 8, wherein said marking is transparent to a user.

10. The method of claim 8, wherein said marking is visible to a user.

11. The method of claim 10, wherein said marking includes a change in an appearance of an icon corresponding to said managed component.

12. The method of claim 1, wherein said step of propagating includes starting said managed component when said change in availability includes a resource becoming available and stopping said managed component when said change in availability includes a resource becoming unavailable.

13. The method of claim 1, wherein said step of propagating includes notifying said managed component of said change in availability.

14. The method of claim 13, wherein said notifying includes an address of a resource when said change in availability includes a resource becoming available.

15. The method of claim 7, wherein said step of propagating includes notifying said managed component of an increase in functionality of said managed component when said change in availability includes a resource becoming available and a decrease in functionality of said managed component when said change in availability includes a resource becoming unavailable.

16. An apparatus for resource management, comprising:
a media manager adapted to detect a change in availability of one or more resources;
a resource inventory having information indicative of one or more dependencies between said one or more resources and one or more managed components; and
a management agent adapted to propagate said change in availability to a managed component when a dependency exists between said managed component and said one or more resources.

17. The apparatus of claim 16, wherein said media manager is adapted to detect at least one or an insertion or a removal of a medium containing said one or more resources.

18. The apparatus of claim 16, wherein said resource inventory includes a dependency graph.

19. The apparatus of claim 16, wherein said managed component is at least one of a software application and a data store.

20. The apparatus of claim 16, wherein said media agent is adapted to mark said managed component as usable when said change in availability includes a resource becoming available and as unusable when said change in availability includes a resource becoming unavailable.

21. The apparatus of claim 16, wherein said media agent is adapted to notify said managed component of an increase in functionality of said managed component when said change in availability includes a resource becoming available and a decrease in functionality of said managed component when said change in availability includes a resource becoming unavailable.

22. A program product, comprising machine readable program code for causing a machine to perform the following method steps:
detecting a change in availability of one or more resources;
determining whether a dependency exists between said one or more resources and a managed component; and
propagating said change in availability to said managed component when said step of determining determines the existence of a dependency.

23. The program product of claim 22, wherein said machine readable program code is further configured to mark said managed component as usable when said change in availability includes a resource becoming available and as unusable when said change in availability includes a resource becoming unavailable.

24. The program product of claim 22, wherein said machine readable program code is further configured to notify said managed component of an increase in functionality of said managed component when said change in availability includes a resource becoming available and a decrease in functionality of said managed component when said change in availability includes a resource becoming unavailable.
